(19) United States
(12) Patent Application Publication
(10) Pub. No.: US 2006/0001647 A1
(43) Pub. Date: Jan. 5, 2006

(54) Hand-held display device and method of controlling displayed content

(76) Inventor: David Carroll, Green Valley, AZ (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/112,308

(22) Filed: Apr. 21, 2005

Related U.S. Application Data
(60) Provisional application No. 60/563,937, filed on Apr. 21, 2004.
(60) Provisional application No. 60/564,631, filed on Apr. 21, 2004.

(51) Int. Cl. G09G 5/00

(52) U.S. Cl. 345/156

(57) ABSTRACT

A method and device for altering content displayed on a display screen of a hand-held display device by a user handling the hand-held device. The method includes capturing a first user image of the user relative to the device. A second user image of the user relative to the device is subsequently captured. A spatial attribute of the first user image is compared with a corresponding spatial attribute of the second user image. Finally, content displayed on the display screen is altered based upon the comparison. In one embodiment, the content displayed on the display screen is altered by zooming, panning, or tilting (i.e., scrolling) the displayed content.

### CROSS-REFERENCE TO RELATED APPLICATIONS

The subject matter of this application is related to the subject matter of U.S. Provisional Patent Application Ser. No. 60/563,937, filed Apr. 21, 2004 and entitled “Mobile Computing Devices” (Attorney Docket No. P374.102.101) and U.S. Provisional Patent Application Ser. No. 60/564,631, filed Apr. 21, 2004 and entitled “Mobile Computing Devices” (Attorney Docket No. P374.103.101), priority to which is claimed under 35 U.S.C. §119(e) and an entirety of both of which are incorporated herein by reference.

### BACKGROUND

The present invention relates to hand-held electronic devices having a display screen. In particular, the present invention relates to a device and method for altering or moving (e.g., browsing) the content displayed on a hand-held device display screen and for selecting a desired content sub-set from otherwise moving displayed content.

A wide variety of hand-held, electronic devices include a display screen for displaying information or content to the user. Exemplary devices include portable computing device, personal digital assistants, mobile phones, digital cameras, etc. To facilitate mobility of these and other hand-held electronic devices, the display screen is relatively small, especially when compared to conventional desktop computer display screens. This physical size requirement inherently limits the amount and/or format of information displayed on the hand-held device display screen at any one point in time. That is to say, while other components (e.g., processor, memory, etc.) associated with most hand-held electronic display devices are normally capable of electronically maintaining large data items (e.g., spreadsheets, images, word processing documents, webpages, etc.), the limited size of the actual display screen and user comprehension needs dictate that only a portion of an individual item can be displayed at any one time. Given that many items are formatted for display on a desktop computer display screen, partial displays on a hand-held display screen are a common occurrence.

For example, a user may wish to view an internet website page via the hand-held device display screen. Many website pages are formatted (e.g., amount and font size of text, images, etc.) for viewing on a desktop computer display screen. Were this same content to be reduced in size to “fit” on the hand-held device's reduced-sized display screen, it may be virtually impossible for the viewer to comprehend (e.g., read) the content thereof. Instead, the hand-held display device's processor selects a portion of the desired webpage for display on the display screen (e.g., the hand-held display device's display screen displays one-eighth of the content that would otherwise be shown in its entirety on a “standard” desktop computer display screen).

To account for the physical size limitations associated with hand-held device display screens, most of these devices provide user-browsing functions. These functions typically include zoom (i.e., displayed content is enlarged or reduced), pan (i.e., displayed content “moves” horizontally left-to-right or right-to-left relative to the display screen), and tilt or scroll (i.e., displayed content “moves” vertically up or down relative to the display screen). With these features, then, a user can readily “move” about and view all portions of a particular item that is otherwise being displayed on a truncated basis..

A typical mechanism by which a user can effectuate “browsing” or other displayed content alterations entails manual mouse or touch screen activation. For example, the hand-held display device can include a touch pad with touch keys labeled “zoom,” “pan,” and “tilt”. Selecting or depressing one of these touch keys (such as with the user's finger and/or a stylus) causes the hand-held device to alter the displayed content in a corresponding fashion. While this approach is widely accepted and understood by most users, it is often times highly inconvenient. As a point of reference, conventional browsing mechanisms require both of the user's hands; one hand holding the device and the other hand operating the browse mechanism (e.g., manipulating the stylus, pressing the touch key, etc.). In many instances, both of the user's hands are not readily available. For example, a user may be traveling in an environment requiring that one of the user's hands holds onto a structure to maintain stability (e.g., a user standing on a train while holding a support strap). Similarly, the user may be in an environment that does not provide a flat, stable surface for supporting the hand-held device during a browsing operation. Also, many users may not posses the manual dexterity required to operate the relatively small keys associated with a hand-held electronic device. Even further, and perhaps most problematic, purchasers of hand-held display devices have come to expect increasing levels of operating simplicity and convenience. As a result, users may be annoyed by any perceived inconvenience (such as two-handed browsing) that otherwise detracts from true “mobility” of an electronic hand-held display device. This convenience factor may reduce the user's satisfaction with a particular hand-held display device, a situation clearly not desired by the device manufacturer.

In light of the above concerns, efforts have been made to facilitate hand-held device display screen browsing in a manner that does not require both of the user's hands. In particular, efforts have been made to incorporate sensors into the hand-held device that operate to sense and quantity movements of the device relative to the user and/or relative to a “standard” position (e.g., relative to the earth). Displayed content is then browsed or altered in a manner corresponding with the sensed movements. For example, PCT Publication No. WO 01/27735 entitled “Operation Method of User Interface of Hand-Held Device” describes a hand-held display device including an acceleration measurement circuit for detecting certain movements of the device in three-dimensional space during use thereof, with displayed data changing in a manner corresponding with the sensed movements in a cause-consequence relationship. Similarly, PCT Publication No. WO 98/14863 entitled “Hand-Held Image Display Device” describes a hand-held image display device including two tilt sensors capable of sensing tilting or rotation of the device about a particular axis. The displayed image scrolls in the direction the hand-held device is rotated via reference to the tilt sensor information. Also, U.S. Patent Application Publication No. 2002/0175896 A1 entitled “Method and Device for Browsing Information on a Display” describes a hand-held device incorporating an acceleration sensor or other device for calculating a tilt of the hand-held device relative to a reference tilt angle (that in turn is defined with reference to the earth). In addition, a video camera can be used to measure the orientation and location of the hand-held device relative to the user such as by measuring the distance to a certain reference point, thus facilitating measurement of tilting or movement.

With the above-described techniques, as well as other suggested concepts, the hand-held device must include additional, discrete sensors, and rely upon complicated algorithms for measuring spatial characteristics of the hand-held device relative to the earth and/or relative to the user. These sensors increase overall costs. Further, the measurement-deduction algorithms occupy significant memory space and processing speed, and may not be accurate.

Regardless of the manner in which display screen content browsing is facilitated, an additional concern is the ability of the user to readily select or act upon a desired sub-set of an otherwise moving display content. For example, where a browsing feature is employed to “move” displayed content in a left-to-right fashion (i.e., pan), and the user wishes to zoom on a particular item being displayed, link to an internet website address being displayed, etc., the user must stop the panning action, move a cursor (e.g., such as a mouse-controlled cursor) over the desired content, and then initiate the desired activity. As previously described, many conventional hand-held display device browsing features require cursor movement to effectuate the desired browsing operation, making it impossible to simultaneously “stop” the browsing operation and act upon a desired content sub-set. Similarly, with suggested sensor-based browsing mechanisms in which the user simply rotates or moves the hand-held device to effectuate the browsing operation, the cursor will “move” with the moving display. Thus, the user must follow a first manual sequence to stop browsing (e.g., depress a touch key), followed by a second manual sequence to reposition the cursor “over” the desired content sub-set. Again, any hand-held display device operating requirement that is even perceived as being inconvenient can undesirably detract from the user's overall satisfaction.

Hand-held electronic display devices continue to increase in popularity. Many features associated with such devices, such as display clarity, processing speed, etc., have undergone multiple improvements. However, the method by which such devices facilitate display content browsing and/or action upon desired content has remained essentially unchanged. Thus, several areas for improvement exist.

### SUMMARY

One aspect of the present invention relates to a method for altering or browsing content displayed on a display screen of a hand-held device by a user handling the hand-held device. The method includes capturing a first user image of the user relative to the device. A second user image of the user relative to the device is subsequently captured. A spatial attribute of the first user image is compared with a corresponding spatial attribute of the second user image. Finally, content displayed on the display screen is altered based upon the comparison. In one embodiment, the content displayed on the display screen is altered by zooming, panning, or tilting (i.e., scrolling) the displayed content. In another embodiment, the compared spatial attributes relate to an area of the user image relative to a reference frame. In another embodiment, the spatial attributes relate to a position of the user image (or identifiable feature thereof) relative to a reference frame.

Another aspect of the present invention relates to a hand-held device for displaying content to a user. The hand-held device includes a housing, a display screen, a camera system, and a processor. The housing maintains the display screen, the camera system, and the processor. In this regard, the camera system includes a lens that is positioned by the housing such that the lens and the display screen face in a similar direction. The processor is electronically connected to the display screen and the camera system. Further, the processor is adapted to prompt the display screen to display content. The processor is further adapted to capture a first image of a user of the hand-held device relative to the hand-held device via the camera system, and determine a spatial attribute of the first user image. Similarly, the processor is adapted to capture a second image of the user relative to the hand-held device and determine a spatial attribute of the second user image otherwise corresponding with the spatial attribute of the first user image. Finally, the processor is adapted to compare the spatial attributes of the first and second images and alter content displayed on the display screen based upon the comparison. With this construction, the hand-held device is capable of, for example, zooming, panning, or tilting the displayed content based upon a comparison of captured images.

Yet another aspect of the present invention relates to a method of operating a hand-held display device including a display screen. The method includes prompting the display of a fixed cursor on the display screen, a location of the fixed cursor being fixed relative to a border of the display screen. Moving content is displayed on the display screen. To this end, the moving content is selected from the group consisting of zooming, panning, and tilting content. Regardless, the fixed cursor is displayed on the display screen over the moving content. The hand-held device is then operated to position a desired content sub-set at an activation position on the display screen. The activation position is dictated by a location of the fixed cursor. Finally, with the desired content sub-set in the activation position, the hand-held device is prompted to alter the content displayed on the display screen based upon reference to the desired content sub-set. With this methodology, the fixed cursor provides a convenient means for effectuating displayed content changes, such as zooming, linking, etc., while viewing a moving display.

Yet another aspect of the present invention relates to a hand-held display device including a display screen and a processor. The processor controls displays on the display screen. To this end, the processor is adapted to cause the display screen to display a fixed cursor. A displayed location of the fixed cursor is fixed relative to a border of the display screen. The processor is further adapted to cause the display screen to display moving content under the fixed cursor, whereby the moving content is zooming, panning, and/or tilting content. With this in mind, the processor is adapted to electronically monitor a relationship between the fixed cursor and the moving display content and alter the content displayed on the display screen based upon a content sub-set associated with the fixed cursor upon receiving a prompt to alter the content. With this configuration, the fixed cursor remains stationary relative to the display screen while displayed content is otherwise zoomed, panned, and/or tilted, allowing a user to easily act upon a desired content sub-set via the fixed cursor.

### BRIEF DESCRIPTION OF THE DRAWINGS

Embodiments of the invention will be described with respect to the figures, in which like reference numerals denote like elements, and in which:

FIG. 1A is a simplified, front view of a hand-held display device in accordance with one embodiment of the present invention;

FIG. 1B is a block diagram of the hand-held display device of FIG. 1A;

FIGS. 2A-2E illustrate, in simplified form, browsing of content on a hand-held device display screen;

FIG. 3 is a flow diagram illustrating one embodiment of a method for operating the display device of FIG. 1A to alter displayed content in accordance with the present invention;

FIG. 4 is a simplified view of an image captured by the hand-held display device of FIG. 1A;

FIGS. 5A and 5B illustrate simplified captured user images for performing a zooming operation in accordance with the present invention;

FIGS. 6A and 6B are screen displays illustrating a zooming operation corresponding with the user images of FIGS. 5A and 5B;

FIGS. 7A and 7B illustrate simplified captured user images for performing a panning operation in accordance with the present invention;

FIGS. 8A and 8B are screen displays illustrating a panning operation corresponding with the user images of FIGS. 7A and 7B;

FIGS. 9A and 9B illustrate simplified captured user images for performing a tilting/scrolling operation in accordance with the present invention;

FIGS. 10A and 10B are screen displays illustrating a tilting/scrolling operation corresponding with the user images of FIGS. 9A and 9B;

FIG. 11A is a simplified, front view of a hand-held display device in accordance with another embodiment of the present invention;

FIG. 11B is a block diagram of the hand-held display device of FIG. 11A; and

FIG. 11C is a front view of the device of FIG. 11A with a fixed cursor removed from a display screen; and

FIGS. 12A-12E illustrate use of the hand-held display device of FIG. 11A.

### DETAILED DESCRIPTION

I. Zoom/Pan/Tilt

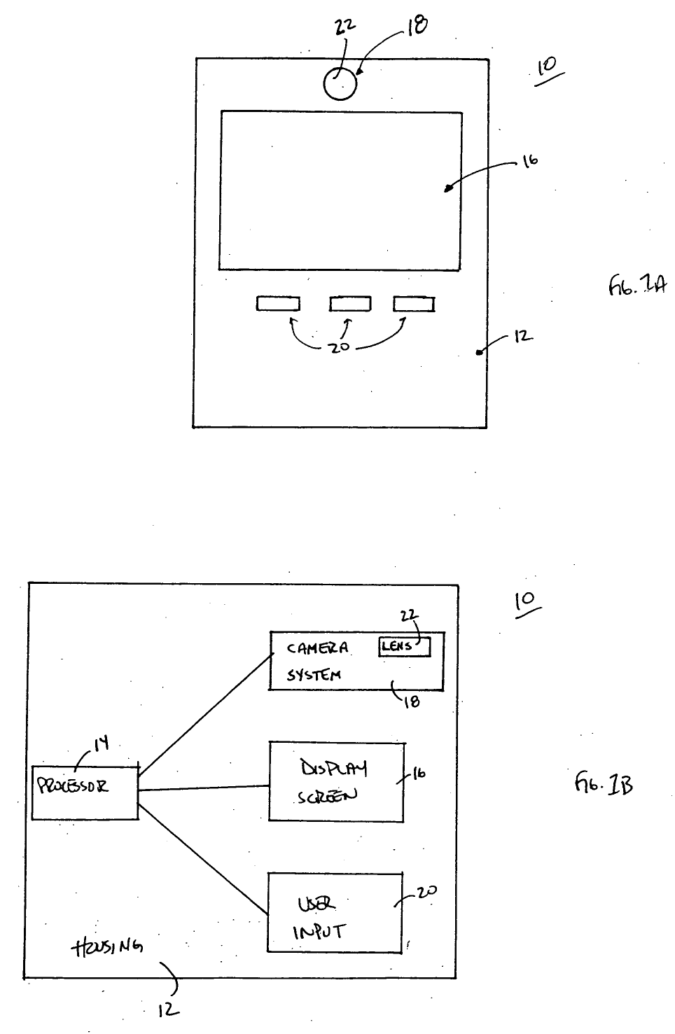

One embodiment of the present invention relates to a hand-held display device 10 as shown in FIGS. 1A and 1B. The hand-held display device 10 includes a housing 12, a processor 14, a display screen 16, a camera system 18, and a user input 20. The various components are described in greater detail below. In general terms, however, the housing 12 maintains the processor 14, the display screen 16, the camera system 18, and the user input 20. The processor 14 is electronically connected to the display screen 16, the camera system 18, and the user input 20. The camera system 18 includes a lens 22. During use, the processor 14 operates to effectuate one or more browsing operations in which content displayed on the display screen 16 is altered via reference to images captured via the camera system 18. In particular, the camera system 18 is operated to capture images of a user (not shown) otherwise handling the hand-held device 10. Characteristic(s) of the captured images will vary from one another depending upon how the user positions and/or orients the hand-held device 10 relative to himself/herself. The processor 14 effectuates desired display content changes (e.g., browsing) based upon differences between the captured images.

In general terms, the hand-held device 10 can assume a wide variety of forms that otherwise incorporate a number of different operational features. For example, the hand-held device 10 can be a mobile phone, a hand-held camera, a portable computing device, etc. The necessary components and software for performing the desired operations associated with the designated end use is not necessarily shown in FIGS. 1A and 1B, but are readily incorporated therein (e.g., input/output ports, wireless communication modules, etc.). Regardless, the display screen 16 is of a type known in the art, and content displayed thereon is dictated by the processor 14. To this end, the processor 14 includes or is connected to a memory device. As is known in the art, this configuration allows the processor 14 to generate receive, store, and/or generate items, and prompt corresponding displays on the display screen 16 such as pictures, word processing documents, spreadsheets, characters, text, links, video, internet webpages, etc.

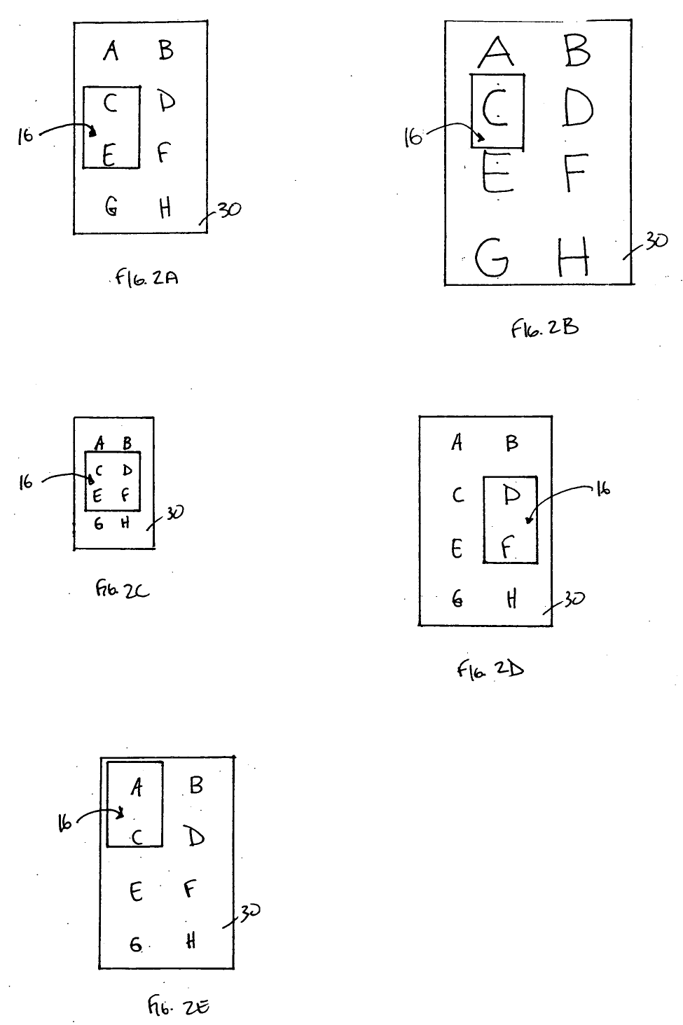

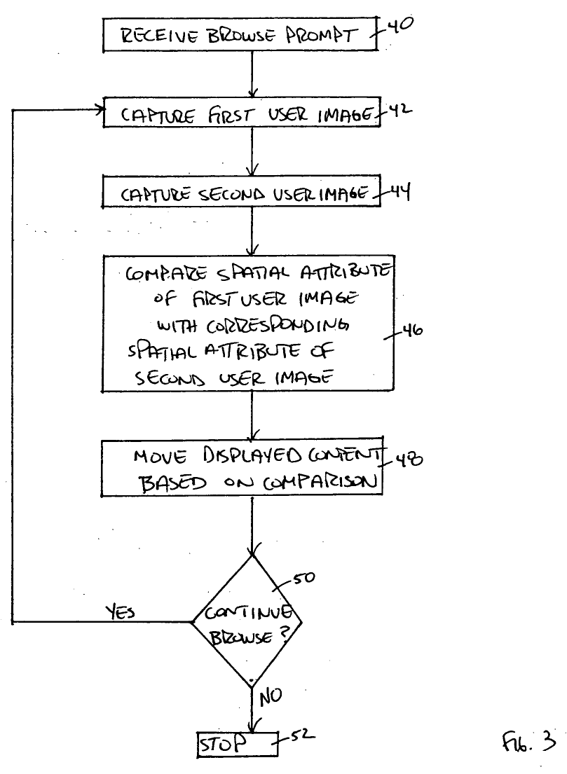

By way of reference, the display screen 16 is of a relatively small physical size, for example on the order of 2 inches×4 inches, and can incorporate a wide variety of technologies (e.g., pixel size, etc). Regardless of exact dimensions, the limited size of the display screen 16 renders displaying an entirety of a desired item difficult. By way of reference, FIG. 2A illustrates a hypothetical document 30 that a user (not shown) of the hand-held device 10 wishes to view on the display screen 16. The document 30 consists of multiple characters generically illustrated as “A-H”. In order to be legible to the user, only a portion of the characters “A-H” can be displayed on the display screen 16 at any one time. A remainder of the document 30, though not displayed on the display screen 16, is stored in the memory of the hand-held device 10. With this in mind, FIG. 2A schematically illustrates the display screen 16 displaying the characters “C” and “E”.

One possible browsing operation is generally referred to as “zoom” and entails increasing or decreasing a magnification level of the content displayed on the display screen 16. For example, FIG. 2B illustrates a zoom operation in which the document 30 is effectively magnified by the processor 14, such that the character “C” appears on the display screen 16 in enlarged form as compared to FIG. 2A. Conversely, FIG. 2C illustrates a decreased zoom operation in which the document 30 is effectively reduced in size such that characters “C-F” are displayed on the display screen 16.

An additional browsing operation is commonly referred to as “pan” and relates to horizontally moving or panning the document 30 across the display screen 16 in a left-to-right or right-to-left fashion. For example, FIG. 2D illustrates (as compared to FIG. 2A) a panning of the document 30 such that the display screen 16 displays the characters “D” and “F”.

Finally, an additional browsing feature is commonly referred to as “tilt” and relates to vertical moving, scrolling, or tilting the document 30 upwardly or downwardly across the display screen 16. For example, FIG. 2E illustrates (relative to FIG. 2A) an upward tilt operation whereby the display screen 16 displays the characters “A” and “C”.

With the above conventions in mind, and returning to FIGS. 1A and 1B, the hand-held device 10 performs one or more of the above-described browsing operations based solely upon images captured by the camera system 18. The camera system 18 can assume a wide variety of forms (e.g., a CCD camera). Regardless of exact design, the camera system 18 includes the lens 22 that is otherwise positioned to facilitate obtaining images of a user (not shown) handling the hand-held device 10 and in particular, viewing or facing the display screen 16. It will be recognized that many currently available hand-held display devices, as well as future products, already incorporate a camera system including a lens “facing” the user. These configurations are typically employed to capture an image of the user (or some other image desired by the user) and then display this image on the display screen 16 and/or store the image for subsequent transmission or reproduction on a separate device. As such, the physical component requirements associated with the hand-held device 10 of the present invention are currently available. However, currently available devices are unable to effectuate changes in content displayed on the display screen 16 via the captured images.

In particular, FIG. 3 provides a flow diagram illustrating a method of operating the hand-held device 10, in one embodiment performed by the processor 14, for performing one or more of the above-described browsing functions. Beginning at step 40, and with additional reference to FIGS. 1A and 1B, a prompt is received from the user (not shown) to alter the content being displayed on the display screen 16 (e.g., a desired browsing function). To this end, the user input 20 can be employed to facilitate prompting of a desired browsing operation. The user input 20 can consist of a series of appropriately labeled touch keys (such as “zoom,” “pan,” and/or “tilt”). Alternatively, the user input 20 can be a voice recognition module, etc. Regardless, upon receiving a prompt for performing a desired browsing operation, at step 42, a first image of the user is captured (“first user image”).

In one embodiment, the processor 14 activates or prompts the camera system 18 to obtain a current image of what is currently in the field of view of the lens 22. By way of example, FIG. 4 illustrates in highly simplified form one possible image I obtained upon activating or polling the camera system 18. The camera system 18 has a fixed focal length as dictated by the lens 22. This fixed focal length results in a constant or standard reference frame F for every image obtained via the camera system 18. It is recognized that in most situations, the user (not shown) will be operating the hand-held device 10 in an environment having various background attributes. The exemplary image I of FIG. 4 generically illustrates one such background environment. As a point of reference, then, the image I of FIG. 4 can be described as a “user-in-environment image” that collectively includes an image of the user I_{U} and an image of all background subjects that are not otherwise the user (designated generally in FIG. 4 as I_{E}). With these conventions in mind, in one embodiment, the present invention entails identifying the image of the user (or “user image”) I_{U} in the user-in-environment image I and/or distinguishing the user image I_{U} from the non-user portions I_{E} of the image I. Such image analyses techniques are currently employed in “blue screen” imaging techniques whereby software is provided that can readily identify prominent features associated with a human figure (e.g., algorithms directed to recognition of common curve segments corresponding to rounded or oval-shaped human head, neck, and/or shoulders). Alternatively, any other technique for identifying or distinguishing the user image I_{U} relative to the non-user image I_{E} of the user-in-environment image I can be employed. Once identified, the user image I_{U} can be parsed from the user-in-environment image I and a new image generated that includes the user image I_{U} against a “plain” background (e.g., a blue screen). Further, the user image I_{U} can be transformed into a mask image in which only the outline or perimeter of the user image I_{U} is provided. Regardless, a relationship between the user image I_{U} relative to the reference frame F is maintained.

Returning to FIG. 3, a second user image is captured at step 44. The second user image can be captured at any point in time after capturing of the first user image at step 42. Preferably, however, a short delay between image capturing occurs (on the order of 1 second, for example) providing the user (not shown) with sufficient time to move the hand-held device 10 (FIG. 1) relative to the user, or vice-versa, so that the second user image “differs” from the first user image within the context of the reference frame F (FIG. 4).

At step 46, a spatial attribute of the first user image is compared with a corresponding spatial attribute of the second user image. The particular spatial attribute that is the subject of this comparison can take a variety of forms, and may vary depending upon a particular browsing function desired. Specific spatial attribute comparisons are described in greater detail below relative to desired browsing activities. In general terms, however, the spatial attribute of the user images relates to a feature of the user image I_{U} relative to the reference frame F as shown in FIG. 4. For example, the spatial attribute can be a relationship between a size or area of the user image I_{U} relative to an area of the reference frame F, a horizontal or vertical position of a center of the user image I_{U} relative to a designated edge of the reference frame F, a vertical and/or horizontal spacing between an identifiable perimeter point along the user image I_{U} relative to a designated edge of the reference frame F, etc. Regardless, the comparison performed at step 46 identifies a change or difference in the designated spatial attribute between the first and second user images I_{U}.

The results of the above comparison are employed at step 48 to dictate a change or alteration in content displayed on the display screen 16. Once again, this display alteration can be in the form of zooming on the content, panning the content, tilting or scrolling the content, etc. Further, the rate at which the display alteration progresses can be a function of the user image spatial feature comparison. Specific examples of display content alteration or browsing are provided below.

At step 50, a determination is made as to whether the content alteration should continue (e.g., continue the zooming, panning, and/or tilting browsing operation). In one embodiment, reference is made to the user input 20 for making this determination. For example, where the user input 20 includes touch keys, the processor 14 can be adapted to continue a browsing operation so long as a designated key is continually pressed. Alternatively, other touch key operations (e.g., double depressing of a key) can signal that the user (not shown) desires to end a browsing operation.

If it is determined that the browsing operation should cease (“no” at step 50), the browsing method is stopped at step 52. Conversely, where the browsing operation is to continue, the method returns to step 42 at which image(s) of the user are again captured and compared to one another to determine desired browsing functions. Alternatively, the selected browsing operation can simply continue until a request is received from the user (e.g., via the user input 20) to stop.

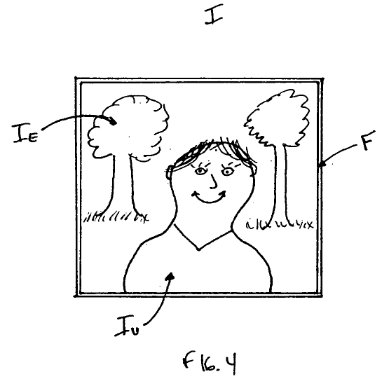

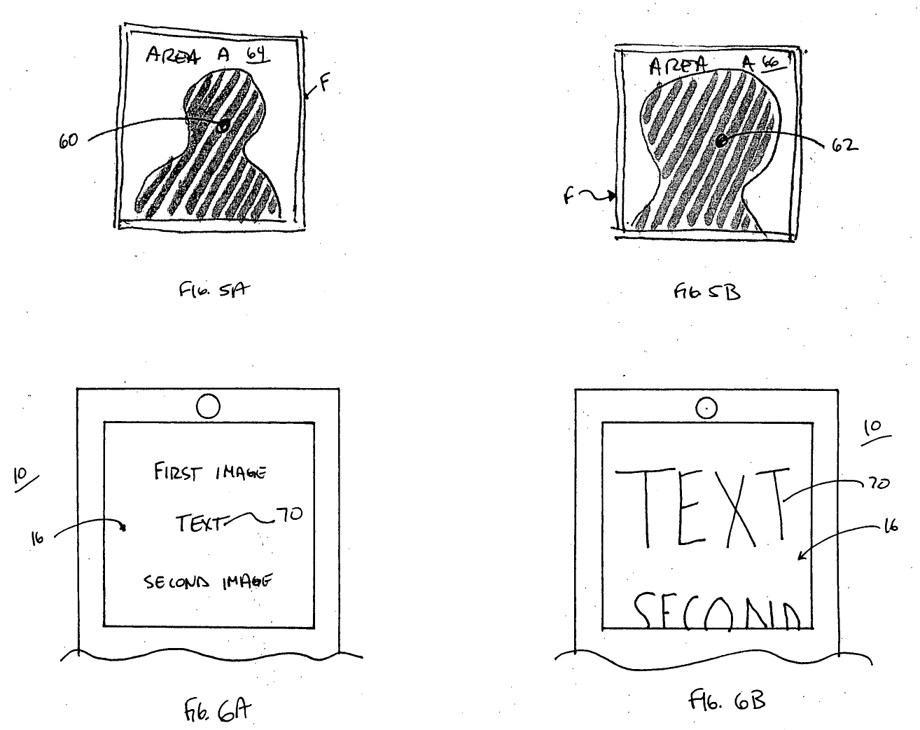

FIGS. 5A, 5B and 6A, 6B illustrate one example of a zoom display content alteration based upon captured images in accordance with one embodiment of the present invention. By way of reference, FIG. 5A illustrates a first user image 60 captured by the hand-held display device 10 (FIGS. 1A and 1B), whereas FIG. 5B illustrates a second user image 62 captured at a later point in time. Once again, each of the user images 60, 62 are, in one embodiment, captured via the camera system 18 (FIGS. 1A and 1B) otherwise having a fixed focal length and/or has an adjustable focal length but is operated such that the focal lengths associated with the first and second user images 60, 62 are identical. Thus, each of the user images 60, 62 are set against the standard reference frame F inherent to the camera system 18 in FIGS. 5A and 5B, respectively. The reference frame F provides a consistent reference point for comparing the user images 60, 62. Though not shown, background image(s) may or may not be associated with the first and second user images 60, 62.

A visual comparison of the first user image 60 (FIG. 5A) with the second user image 62 (FIG. 5B) reveals that the second user image 62 occupies a larger portion of the reference frame F. This is a result of the user (not shown) bringing the hand-held device 10 closer to the user's face and/or vice-versa. With this in mind, in one embodiment, an area of the first user image 60 is then determined or approximated, as is the area of the non-user portion within the reference frame F (designated generally at 64 in FIG. 5A). For example, an area of the reference frame F is known; with the determined or approximated area of the first user image 60 in mind, the area of the non-user portion 64 can be determined by simply subtracting the first user image 60 area from the reference frame F area. Regardless, a ratio of the first user image 60 area relative to the non-user portion 64 is then determined and designated as the spatial attribute of the first user image (step 46 in FIG. 3). A similar relationship is established relative to the second user image 62 (it being noted that in FIG. 5A, the non-user portion associated with the reference frame F/second user image 62 is designated generally at 66). A comparison of the ratios is then performed to dictate zooming and extent and/or rate of the zooming operation. For example, FIG. 6A illustrates an exemplary content 70 displayed on the display screen 16 prior to initiation of the zoom browsing operation. Subsequently, following the comparison of the corresponding spatial attributes of the first and second user images 60, 62, the display screen 16 is prompted to enlarge the content 70 as shown in FIG. 6B. Conversely, a reduction in content magnification can be achieved by moving the hand-held device 10 away from the user, such that the second user image 62 is “smaller” than the first user image. Alternatively, the areas of the first and second user image 60, 62 areas can be determined or approximated, and then compared to one another to determine extent and rate of zoom without reference to the non-user portion area 64 or 66. That is to say, the compared, corresponding spatial attributes associated with the first and second user images 60, 62 can be the image areas or ratios based upon user image area and non-user image areas.

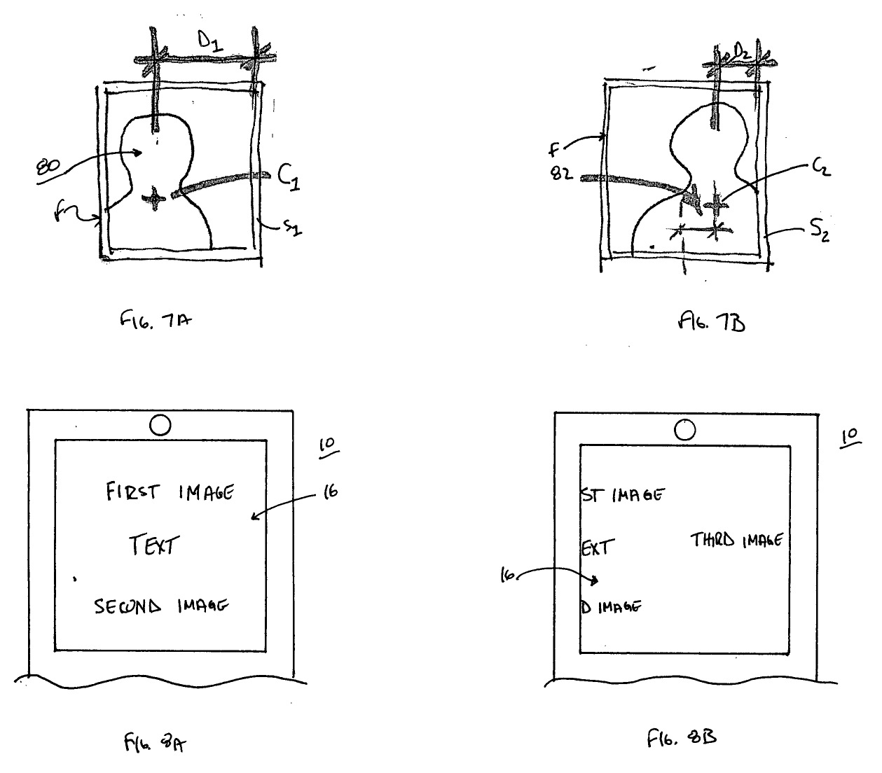

FIGS. 7A, 7B and 8A, 8B illustrate one example of a pan display content alteration based upon captured images in accordance with one embodiment of the present invention. FIG. 7A illustrates a first captured user image 80 relative to the reference frame F, whereas FIG. 7B depicts a second captured user image 82 (captured after capturing the first user image 80) relative to the reference frame F. The difference between FIGS. 7A and 7B reflects the user (not shown) having maneuvered the hand-held device 10 (FIG. 1) from left-to-right relative to the user's body (or vice-versa), such that the second captured user image 82 is in right-more position relative to the reference frame F as compared to the first user image 80 relative to the reference frame F.

In one embodiment, the pan browsing operation is effectuated by first determining or approximating a center C₁ (e.g., center of mass) of the first user image 80 using appropriate algorithms. A relationship between the center C₁ and a vertical side or edge of the reference frame F is then determined or approximated. For example, relative to FIG. 7A, a distance D₁ between the center C₁ of the first user image 80 and a side S₁ of the reference frame F is determined or approximated. Similarly, with respect to FIG. 7B, a center C₂ of the second user image 82 is determined or approximated, and a relationship between the center C₂ and the side S₁ of the reference frame F is made. For example, a distance D₂ between the center C₂ of the second user image 82 and the side S₁ of the reference frame F is determined. Alternatively, the centers C₁ and C₂ can be related to a side of the reference frame F other than the side S₁ (so long as the same, corresponding side is used as the basis for both user images 80, 82). The difference or shift between the corresponding spatial attributes is then made. For example, in one embodiment, D₁ is compared with D₂. The amount or value of this difference or change is employed to effectuate a panning alteration in the content displayed on the display screen 16. The comparison can dictate direction of pan, amount of pan, and/or rate of pan. To this end, FIGS. 8A and 8B illustrate example displayed content and correspond with FIGS. 7A and 7B, respectively. Thus, the change in the first and second images 80, 82 relative to the reference frame F results in the display screen 16 having an altered display content from FIG. 8A to 8B. A similar comparison can be made to effectuate a tilt or scroll browsing operation (with the spatial attributes otherwise forming the basis of the captured image comparison being a relationship between a user image center and a horizontal side or edge of the reference frame F).

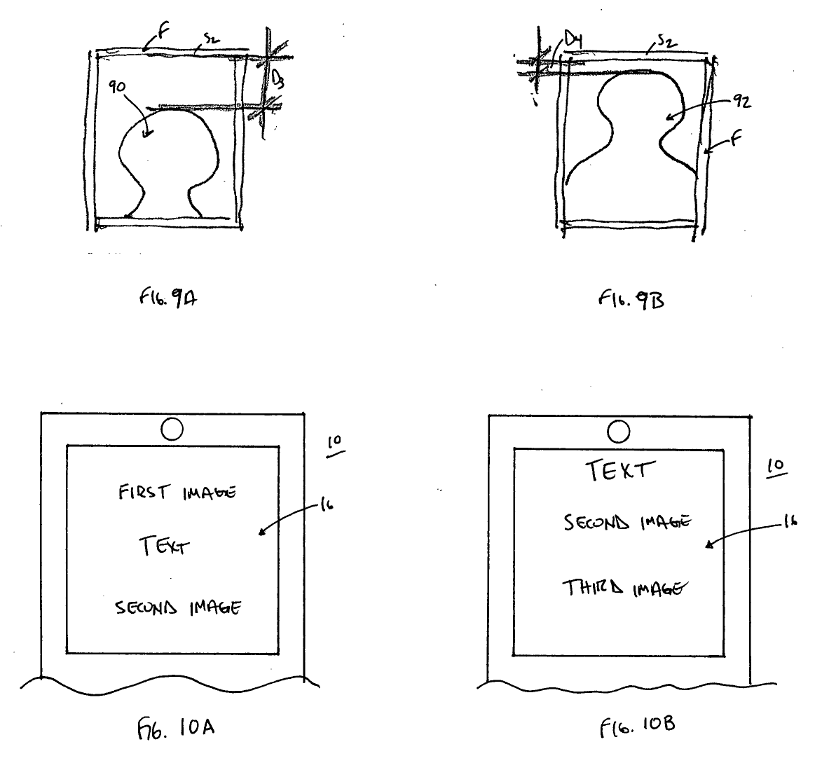

An example of a tilt or scroll display content alteration performed on the basis of captured user images in accordance with one embodiment of the present invention is provided by FIGS. 9A, 9B, and 10A, 10B. FIG. 10A illustrates a first user image 90 relative to the reference frame F, whereas FIG. 10B illustrates a second user image 92 (captured after capturing the first user image 90) relative to the reference frame F. As a point of reference, the difference between FIGS. 9A and 9B is indicative of the user (not shown) lowering the hand-held device 10 (FIG. 1) relative to the user's head and/or “tilting” the hand-held device 10 relative to the user's head (i.e., to a top of the hand-held device 10 is moved away from the user's head while a bottom is moved toward the user's head. In either case, the second user image 92 appears “higher” relative to the reference frame F in FIG. 9B as compared to FIG. 9A. A tilt or scroll browsing operation can be performed by first identifying a feature of the first user image 90 using appropriate algorithms. In one embodiment, the identifiable feature is a top of the user's head. Of course, a wide variety of other attributes can be identified, such as other features of the user's face and/or upper torso, eyes, ears, nose, etc. Regardless, a relationship between the identified feature and a horizontal side or edge S₂ of the reference frame F is determined or approximated to define a spatial attribute of the first user image 90. For example, in one embodiment, a distance D₃ between a top of the first user image 90 and the side S₂ of the reference frame F is determined. Similarly, the same feature of the second user image 92 (e.g., top of the user's head) is identified and a relationship between the identified feature and the corresponding side S₂ of the reference frame F is obtained to define a spatial attribute of the second user image 92 corresponding with a spatial attribute of the first user image 90. For example, a distance D₄ between the top of the second user image 92 and the side S₂ of the reference frame F is determined or approximated.

The corresponding spatial attributes (e.g., D₃ and D₄) are then compared to one another and used as the basis for dictating a desired change in the displayed content. For example, FIGS. 10A and 10B illustrate example displayed content and correspond with FIGS. 9A and 9B, respectively. Thus, where the user tilts a top of the hand-held device 10 away from the user's face (not shown) and/or lowers the hand-held device 10, thus effectuating the change from the first user image 90 to the second image user image 92 illustrated in FIGS. 9A and 9B, the corresponding content displayed on the display screen tilts or scrolls from that shown in FIG. 10A to 10B.

The desired browsing functions can be effectuated in manners varying from those associated with the above-described examples to possibly enhance user friendliness. In more general terms, however, altering content displayed on the display screen (e.g., zooming, panning, and/or tilting browsing functions) is accomplished without the use of a manual mouse or cursor, and does not require additional sensors. Instead, browsing operations are simply controlled by capturing and evaluating changes in user images. Complex calculations to determine precise distances between the user and the hand-held device, changes in orientation of the device relative to the earth, the speed at which the device is re-oriented relative to the user and/or the earth, etc., are not required.

The above-described image capture feature associated with the hand-held display device 10 can alternatively be employed to control operation of the device 10 based upon reference to a known image that is compared with the captured image, or based upon a level of “focus” of a sensed/captured image. For example, the device 10 can be adapted such that where the camera system 18 captures a particular image “known” to the processor 14 (e.g., by reference to an image database maintained by the processor; identifying certain features of the captured image; etc.), a particular activity will occur. In one embodiment, then, the hand-held device 10 is, or includes, a mobile phone. With this configuration, the processor 14 can be adapted such that when the camera system 18 captures an image recognized by the processor 14 to be indicative of a human ear (not shown), the processor 14 automatically transitions to a phone mode of operation. As such, the user is not required to perform any manual activities to initiate use of the hand-held device 10 as a phone other than bringing the hand-held device 10 near the user's ear. Of course, a wide variety of other operational modes can similarly be initiated based upon recognition of pre-designated image; once the processor 14 recognizes that the camera system 18 has captured or otherwise “viewed” the image in question (e.g., one or more fingers, fingers displayed in a particular orientation, etc.), the processor 14 automatically shifts to the designated operational mode.

Similarly, the above-described automatic transition to a particular mode of operation can be based upon a level of focus observed by the camera system 18. In this regard, the processor 14 can be configured such that when the camera system 18 provides an image that cannot be focused, a pre-designated mode of operation is automatically initiated. For example, the pre-designated mode of operation can be a telephone mode of operation. Thus, with this configuration, as the hand-held device 10 is brought toward the user's ear/head, the camera system 18 will not be able to focus on the “image” due to the close proximity of the lens 22 to the user's ear/head. Under these circumstances, the processor 14 is programmed to automatically transition to a mobile phone mode of operation such that the user does not need to perform any manual inputting activities on the hand-held device 10 other than simply raising the hand-held device 10 toward his or her head. Again, a wide variety of other transitional modes can be implicated by an “out of focus” image.

Even further, the hand-held device 10 can be adapted to initiate a first mode of operation upon detecting an out of focus image, and a second mode of operation when a highly dark image is recognized, alone or in combination with a timing factor. For example, and as previously described, when the processor 14 determines that the image being captured by the camera system 18 cannot be focused, a telephone mode of operation is assumed. Subsequently, when a “no light” condition is sensed by the processor 14 via the camera system 18 (such as the user placing his/her thumb over the lens 22), a secondary mode of operation can be implemented by the processor 14, such as operating the hand-held device 10 as a speakerphone. Once light is detected, the processor 14 then returns to the telephone mode of operation. Alternatively, a variety of other related modes of operation can be automatically implemented based upon the above-described “out of focus” and “lack of light” images/conditions.

In addition to controlling zoom/pan/tilt, the processor 14 can control other features of the hand-held device 10 based upon the captured image comparison technique described above. For example, the processor 14 can operate to control a brightness of the display screen 16 depending upon a change in location of the user's head (or other portion of the user) relative to the lens 22. Similarly, display contrast, speaker volume, etc., can also be controlled. With these applications, the hand-held device 10 can further incorporate a separate user input whereby the user can inform the processor 14 that a desired feature control based upon proximity of the user's head to the hand-held device 10 is desired.

In alternative embodiments, the hand-held device is adapted to provide the user with the ability to select, set a “sensitivity” of the device 10 to motion and/or scale of movement. For example, a user may desire to effectuate zoom/pan/tilt (or other feature) control only when the user moves the hand-held device 10 in a relatively slow fashion, thus avoiding possible changes in zoom/pan/tilt (or other features) during normal use whereby the hand-held device 10 will naturally move slightly relative to the user when held in the user's hand. Similarly, the user may desire to effectuate zoom/pan/tilt (or other feature) control only in response to large-scale movements of the device 10 relative to the user (again, to avoid a situation where the device 10 naturally moves relatively slightly during normal use but when no change in display content is desired). To this end, the hand-held device 10 can provide a dedicated switch by which a user can alter the pre-programmed sensitivity level provided with the processor 14. Regardless, the hand-held device 10 can provide a selected sensitivity or selectable sensitivity such that only large-scale and/or relatively slow movements effectuate zoom/pan/tilt changes, and smaller scale movements of the hand-held device 10 relative to the user are disregarded.

In another alternative embodiment, the hand-held device 10 employs a fingerprint identification imaging system as, or as part of, the camera system 18. With this configuration, the processor 14 is adapted to recognize a fingerprint of the owner of the hand-held device 10 via biometric image analysis, such as by using a fingerprint identification pad as the lens 22. For example, then, the hand-held device 10 can be configured such that it will only operate upon sensing (based on image analysis) the fingerprint of the assigned owner of the hand-held device 10. Subsequently, the processor 14 performs pan and tilt control based upon an image analysis of motion or movement of the user's finger or thumb along/relative to the identification pad in a manner highly similar to the image analysis described above. With respect to zoom control, with this embodiment, a separate biometric finger/thumb identification pad can be provided apart from the fingerprint identification pad otherwise used to control pan/tilt, and specifically dedicated to effectuate zoom control. Depending upon the time a user places his or her finger over this dedicated pad, zoom can be increased or decreased. Alternatively, zoom can be controlled based upon left and right motion of the user's finger/thumb relative to the dedicated pad. Even further, the fingerprint identification image system can include a pressure gauge/sensor associated with the fingerprint imaging pad. Depending upon the sensed pressure (e.g., the force at which the user “presses” against the pad) zoom can be controlled. In either case, the fingerprint identification image capture pad can be integrated into the surface of a mouse-like pad otherwise provided with the hand-held device 10, having a different texture as compared to a texture of the remainder of the mouse pad so that the user can easily identify the touch pad location for effectuating zoom/pan/tilt control.

II. Fixed Cursor

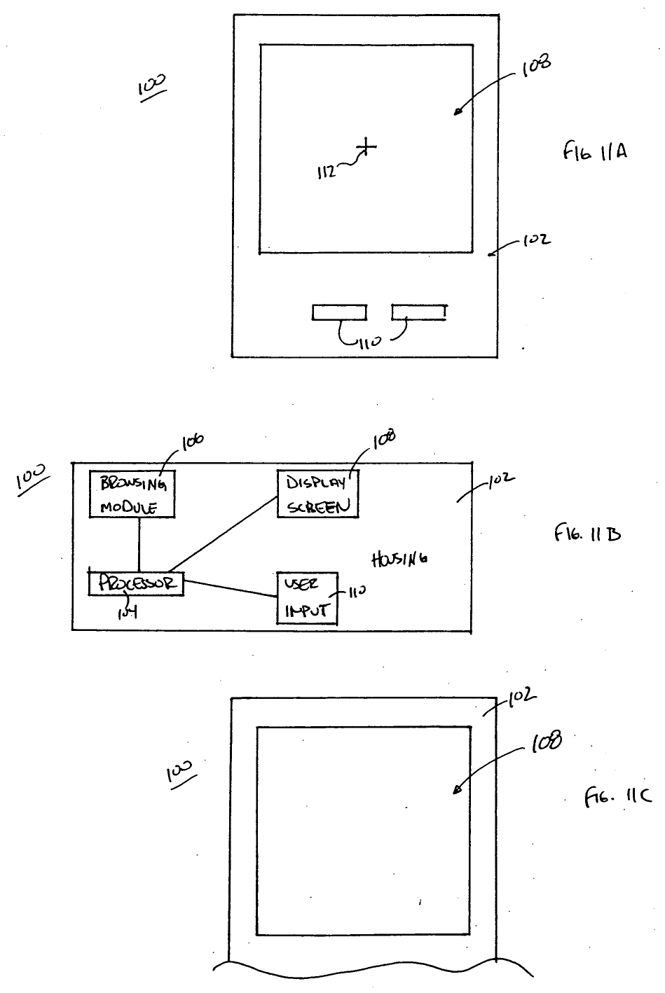

Another embodiment of a hand-held display device 100 in accordance with another embodiment of the present invention is shown in FIGS. 11A and 11B. The device 100 includes a housing 102, a processor 104, a browsing module 106, a display screen 108, and a user input 110. Details on the various components are provided below. In general terms, however, the housing 102 maintains the various components 104-110. The processor 104 is electronically connected to the display screen 108 and the user input 110. The browsing module 106 is also connected to, or portions are provided as part of, the processor 104. The processor 104 dictates the display of content on the display screen 108, with the browsing module 106 facilitating movement or browsing of displayed content. Further, the processor 104 is adapted to selectively display a fixed cursor 112 on the display screen 108. During use, the fixed cursor 112 appears fixed on the display screen 108 relative to other content being simultaneously displayed and moved across the display screen 108. Where desired, a sub-set of the displayed content can be readily associated with the fixed cursor 112 and acted upon as desired by a user (not shown).

The hand-held display device 100 can assume a wide variety of forms and incorporate a number of different components/features commensurate with a desired end-use. For example, the hand-held display device 100 can be akin to a mobile phone, portable computing device, camera, etc. Regardless, the display screen 108 is used to display desired content (e.g., word processing documents, forms, spreadsheets, images, internet webpages, etc.). Due to an inherently small physical size of the display screen 108, it is often times necessary to display only portions of a particular item on the display screen 108. With this in mind, the hand-held display device 100 is provided with the browsing module 106 that facilitates “browsing” content on the display screen 108. The browsing module 106 can assume a wide variety of forms. In one embodiment, the browsing module 106 employs captured user images to effectuate desired browsing functions, such as that associated with the hand-held display device 10 previously described. Alternatively, a number of other browsing enablement techniques can be employed, such as conventional cursor movements, touch screens or keys, stylus interface, sensors and related algorithms (e.g., acceleration sensors), etc.

Regardless of how browsing of content displayed on the display screen 108 is facilitated, the processor 104 is adapted to establish and display the fixed cursor 112 during a browsing operation. The fixed cursor 112 can be permanently displayed on the display device 108. Alternatively, the hand-held display device 100 can be adapted such that the fixed cursor 112 appears only when activated or requested by the user (not shown), such as via an appropriate touch key or voice module provided by the user input 110. To facilitate a better understanding of the fixed cursor 112, FIG. 11C illustrates the hand-held display device 100 with the fixed cursor 112 (FIG. 11A) removed from the display screen 108. While the fixed cursor 112 is illustrated in FIG. 11A as a “+”, a wide variety of other cursor designations, characters, and/or designs, are equally acceptable.

In addition to causing the display screen 108 to display the fixed cursor 112, the processor 104 electronically monitors and maintains a relationship between a virtual representation of the fixed cursor 112 relative to a virtual representation of an item being displayed on the display screen 108. For example, where the item being displayed on the display screen 108 is a spreadsheet, the processor 104, maintains, such as via associated memory, an electronic version of the information from which the spreadsheet is generated. As portions of the spreadsheet are browsed or “moved” on the display screen 108, the data representative of the particular content currently displayed “beneath” the displayed fixed cursor 112 is electronically managed and continuously “known” by the processor 104.

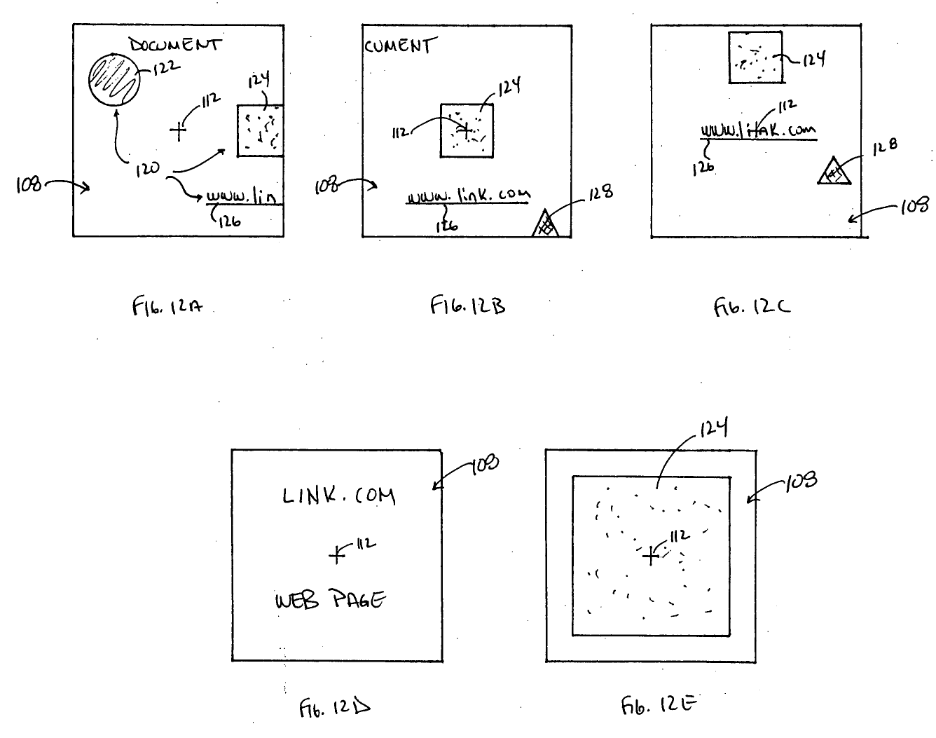

With the above conventions in mind, FIGS. 12A-12E illustrate a method of using the hand-held display device 100 in accordance with one embodiment of the present invention. As a point of reference, FIG. 12A illustrates the display screen 108 as displaying content 120 along with the fixed cursor 112. Once again, the content 120 can assume a wide variety of forms, and with the embodiment of FIG. 12A includes content sub-sets 122, 124, and 126. In most instances, the display screen 108 is displaying only a portion of a particular item stored by the processor 104 (FIG. 11B) such that a number of additional content sub-sets may be available for display on the display screen 108, but are not otherwise currently displayed on the display screen 108.

Browsing operation(s) are then initiated whereby the content displayed on the display screen 108 is altered or moved. For example, a pan browse operation can be utilized to transition the display screen 108 from the display of FIG. 12A to the display of FIG. 12B. Each of the content sub-sets 122-126 has “shifted” to the left (relative to the orientation of FIGS. 12A and 12B) along the display screen 108. An additional content sub-set 128 is now displayed on the display screen 108. However, the fixed cursor 112 remains stationary or fixed relative to a border of the display screen 108 during this content movement.

FIG. 12C represents a further transition or tilt/scroll operation in which the content 120 has moved horizontally along the display screen 108. That is to say, each of the content sub-sets 122-128 has moved horizontally upwardly relative to the positions of FIG. 12B. Once again, the fixed cursor remains stationary relative to the display screen 108 border. More particularly, the browsing operation has positioned the content sub-set 126 under the fixed cursor 112. With the one embodiment of FIG. 12C, the content sub-set 126 is an internet website address. Once the content has been “moved” along the display screen 108 (again, via a browsing operation provided by the browsing module 106 (FIG. 11B)) “under” the fixed cursor 112 (or to some other location enabled by the fixed cursor 112), the content sub-set 126 can be acted upon by the hand-held display device 100. For example, the user (not shown) can initiate a desired action, such as linking to the internet website address identified by the content sub-set 126, by interfacing with the user input 110 (FIG. 11A). For example, a button can be depressed. Because the processor 104 continuously electronically monitors content data currently associated with the fixed cursor 112, the processor 104 is thus able to perform the desired activity, such as changing the content displayed on the display screen 108 to illustrate the linked website/webpage (or a portion thereof) as shown in FIG. 12D.

Another exemplary action or change in display facilitated by the fixed cursor 112 is provided by a comparison of FIGS. 12B and 12E. In FIG. 12B the content 120 displayed on the display screen 108 has been browsed or moved such that the content sub-set 124 is “under” the fixed cursor 112. Where desired by the user (not shown), the content sub-set 124 can be acted upon, for example performing a zoom operation resulting in the display shown in FIG. 12E.

The hand-held display device 100 incorporating the fixed cursor 112 and related method of use provides distinct improvements over conventional hand-held display device browsing techniques. Unlike conventional approaches, the fixed cursor 112 does not “move” with movement of displayed content. To act upon a desired content sub-set, the user simply operates the hand-held display device 100 to position the desired content sub-set at or near the fixed cursor 112 for subsequent action thereon. This approach facilitates single-handed browsing and display changes by the user.

Although the present invention has been described with reference to preferred embodiments, workers skilled in the art will recognize that changes can be made in form and detail without departing from the spirit and scope of the present invention.

What is claimed is:

1. A method for altering content displayed on a display screen of a hand-held display device, the method comprising:
capturing a first user image of a user relative to the device;
capturing a second user image of the user relative to the device;
comparing a spatial attribute of the first user image with a corresponding spatial attribute of the second user image; and
altering content displayed on the display screen based upon the comparison.

2. The method of claim 1, wherein the hand-held display device includes a camera having a lens positioned to define a field of view corresponding with a field of view of the display screen, and further wherein capturing the first and second user images includes prompting the camera to obtain an image of the user holding the hand-held display device.

3. The method of claim 1, wherein altering content displayed on the display screen includes at least one of zooming, panning, and tilting.

4. The method of claim 1, wherein capturing a first user image includes:
capturing a first user-in-environment image of the user;
identifying a user portion of the user-in-environment image; and
designating the user portion of the first user-in-environment image as the first user image.

5. The method of claim 4, wherein capturing a second user image includes:
capturing a second user-in-environment image;
identifying a user portion of the second user-in-environment image; and
designating the user portion of the second user-in-environment image as the second user image.

6. The method of claim 5, wherein comparing spatial attributes of the first and second user images includes:
designating a desired image attribute;
identifying the desired image attribute in the first user image;
determining a first image relationship value based upon a correlation of the desired image attribute in the first user image relative to a reference frame;
identifying the desired image attribute in the second user image;
determining a second image relationship value based upon a correlation of the desired image attribute in the second user image relative to the reference frame; and
comparing the first and second image relationship values.

7. The method of claim 6, wherein the desired image attribute is a user image area.

8. The method of claim 7, wherein the first image relationship value is a function of a ratio of a first user image area:area of the reference frame.

9. The method of claim 8, wherein determining a first image relationship value includes:
determining an available area of the reference frame;
designating a non-user image user area as the available area of the reference frame minus the area of the first user area; and
establishing the first image relationship value as the ratio of the non-user image area:first user image area.

10. The method of claim 9, wherein altering the content displayed on the display screen includes:
zooming on the content displayed on the display screen.

11. The method of claim 6, wherein the desired image attribute is a reference point of the user image.

12. The method of claim 11, wherein the reference point is selected from the group consisting of a center of the user image and an identifiable perimeter location of the user image.

13. The method of claim 11, wherein the first image relationship value is a function of a comparison of the reference point of the first user image relative to the reference frame.

14. The method of claim 13, wherein the first image relationship value is a distance between a center of the first user image and a side of the reference frame, and further wherein the second image relationship value is a distance between a center of the second user image and the side of the reference frame.

15. The method of claim 14, wherein altering the content displayed on the display screen includes:
panning the content displayed on the display screen.

16. The method of claim 14, wherein altering the content displayed on the display screen includes:
vertically scrolling the content displayed on the display screen.

17. The method of claim 1, wherein altering content displayed on the display screen includes adjusting at least one of image brightness and image contrast.

18. The method of claim 1, and further comprising:
controlling a volume level of the hand-held device based upon the comparison.

19. The method of claim 1, wherein the first and second user images are fingerprint images.

20. A method of operating a hand-held display device including a display screen, the method comprising:
prompting display of a fixed cursor on the display screen, a location of the fixed cursor being fixed relative to a border of the display screen;
displaying moving content on the display screen, the moving content selected from the group consisting of zooming, panning, and tilting content, wherein the fixed cursor is displayed over the moving content;
operating the hand-held device to position a desired content sub-set at an activation position on the display screen, the activation position dictated by a location of the fixed cursor; and
with the desired content sub-set in the activation position, prompting the hand-held device to alter the display image based upon reference to the desired content sub-set.
